(19) United States
(12) Patent Application Publication
(10) Pub. No.: US 2014/0185268 A1
(43) Pub. Date: Jul. 3, 2014

(54) INSTRUMENT WITH DIAL FOR A MOTOR VEHICLE AND METHOD FOR PRODUCING THE SAME

(71) Applicant: GM Global Technology Operations LLC, Detroit, MI (US)

(72) Inventors: Heiko CHARLE, Ruesselsheim (DE); Peter BRANDT, Aschaffenburg (DE); Wilfred SCHULZ, Eppstein (DE)

(73) Assignee: GM Global Technology Operations LLC, Detroit, MI (US)

(21) Appl. No.: 13/971,892

(22) Filed: Aug. 21, 2013

(30) Foreign Application Priority Data
Aug. 24, 2012 (DE) 10 2012 016 771.7

(51) Int. Cl. G01D 11/28; B29D 11/00

(52) U.S. Cl. CPC G01D 11/28; B29D 11/0074
USPC 362/23.01; 264/1.7; 156/245

(57) ABSTRACT

An instrument is provided with dial for a motor vehicle and a method for producing the same. The dial includes, but is not limited to a support disc, a display area on the support disc and a transparent chromatographically colored ring element, which surrounds the display area. The support disc includes, but is not limited to a transparent light conductor plate, in which the chromatographically colored ring element is arranged. The light conductor plate comprises light-scattering nanoparticles in its volume.

### CROSS-REFERENCE TO RELATED APPLICATION

This application claims priority to Patent Application No. 10 2012 016 771.7, filed Aug. 24, 2012, which is incorporated herein by reference in its entirety.

### TECHNICAL FIELD

The technical field relates to an instrument with a dial for a motor vehicle and a method for producing the same. The dial comprises a support disc and a display area on the support disc.

### BACKGROUND

From the publication DE 202 02 435 U1 a flat illumination device with a real light radiation for a motor vehicle is known. This flat illumination device is particularly provided for interior space illumination. The illumination device comprises a flat plate-shaped light conductor body and a light source arranged such that its emitted light rays are coupled into the light conductor body at the face end.

Structures decoupling light are worked into the at least one flat side of the light conducting body serving for a light radiation. To this end, the flat side of the light conductor body serving for the light radiation is provided with prismatic structures, so that upon edge illumination of the light conductor body the light of the marginally arranged light source reflects into the interior space of the motor vehicle.

Such flat illumination devices can reduce the space requirement of a vehicle, but for illuminating an interior space a high electric power is required, which strains the energy storage unit of the vehicle and thus does not reduce the CO2 emission of the vehicle. For a pointer instrument, the known flat illumination device is not suitable even because it lets a display area of an instrument only appear in a defused manner through the light-scattering structures of the surface.

From the publication DE 101 02 774 A1 a display device is additionally known in particular for a vehicle. This display device comprises a partially light-permeable display area and an illumination device for backlighting the display area. The backlighting comprises a light conductor, which extends on the back of the display area, wherein laterally light can be coupled into the light conductor. The light conductor conducts light to the display area via total reflection. On the smooth surface side of the light conductor facing away from the display area, a reflective coating is applied in individual locations.

In view of the foregoing, at least on object is to create an instrument with a dial having improved visibility and emphasis of a display area and a method for producing the same. In addition, other objects, desirable features and characteristics will become apparent from the subsequent summary and detailed description, and the appended claims, taken in conjunction with the accompanying drawings and this background.

### SUMMARY

An embodiment comprises an instrument with dial for a motor vehicle. In addition, a method is provided for producing the instrument with dial. The dial comprises a support disc, a display area on the support disc and a transparent chromatographically colored ring element, which surrounds the display area. The support disc comprises a transparent light conductor plate, in which the chromatographically colored ring element is arranged. The light conductor plate comprises light-scattering nanoparticles in its volume.

Light-scattering nanoparticles in this context mean particles having a diameter from approximately 10 to approximately 200 nanometers. The nanoparticles scatter the coupled-in light largely isotropically. As nanoparticles, preferentially colorless particles with a refractive index which differs from the light conductor plate by approximately 0.06≦Δn≦approximately 4 are employed. These nanoparticles are arranged distributed in the volume of the light conductor plate and can be additionally surrounded by an envelope layer, which improves the embedding of the nanoparticles in the light conductor material of the light conductor plate. Through embedding the light-scattering nanoparticles, a light conductor material is obtained that is transparent in the non-illuminated state, while it displays an effective light radiation on all sides upon light being coupled in via marginal sides.

Such a dial brings with it the advantage that preferentially white light can be coupled into the light-conducting plastic plate marginally via broadband, which the light-scattering nanoparticles distributed in the volume light up in a broadband manner and preferentially white, so that from the dial fluorescing of the display area of the instrument for example when starting the motor vehicle is possible. Such fluorescing has the advantage that the ring element, which surrounds the display area, lights up in color and thus emphasizes the display area and increases the visibility of the display area. Apart from the foregoing, no additional separate energy source is required for the lighting up and the emphasizing of the display area, since the light scattered on the nanoparticles of the support disc causes the chromatographically colored ring element to light up round about the display area.

In an embodiment, the support disc for this purpose comprises a margin that is coupled to light sources, in particular LEDs (Light Emitting Diodes). Here, the light-conducting characteristics of the light conductor plate of the support disc are utilized in order to feed light into the light conductor plate almost without loss and through the light-scattering nanoparticles with this light, let the scale and number symbols arranged in the display area and the surrounding ring element light up. Here, the color of the scale and number symbols depends on the emitted wavelengths of the light sources, while the color of the lighting-up ring element is defined through color pigments in a transparent plastic.

As material of a light-conducting support disc, a transparent plastic of PMMA (polymethyl methacrylate) with nanoparticles homogeneously distributed in the volume is suitable. Through the homogeneous distribution of the nanoparticles, a bright lighting-up of the scale and number symbols is made possible, which are graphically delimited by a light-absorbent coating on the support disc or a transparent foil fixed on the support disc.

The light sources irradiating an outer margin of the support disc can be installed spaced from the dial and form a central light source for an entire instrument panel. Starting out from these light sources, light conductors can guide point light to the outer margin of the support plate. Coupling-in of the light into the support plate can be affected at various angles and be adjusted to the structure of an instrument housing.

A radial coupling-in in the outer margin of a support disc makes possible a flat instrument, however with unnecessarily widened diameter. For this reason it is provided in a further embodiment of the invention to bend off the outer margin at least in the coupling regions of the light conductors, which does not pose a major problem with the employed polymethyl methacrylate material.

On the other hand it is also possible to chamfer the outer edge, for example, at an angle of approximately 45° and thereafter mirror the chamfer so that with axially oriented light sources the light on the light conductor ends can be directed onto the chamfered edge of the support disc of the dial and because of the mirrored of this chamfered marginal region the light is coupled into the light-scattering nanoparticles without loss. By changing the chamfer angle of such a mirrored chamfered outer edge, the orientation of the light sources can be varied. Here it is also possible to only chamfer and mirror the regions are provided in which light sources.

In a further embodiment, the support disc has a ring groove which surrounds the display area and in which the chromatographically colored ring element is embedded. This includes the advantage that the chromatographically colored ring element, which comprises color pigments in a transparent plastic compound, is excited to light up in color by the scattered light of the nanoparticles surrounding the ring groove in the support disc.

Accordingly, a blue-colored ring element will visually form a blue-illuminated ring about the display area and thus direct the attention of the driver to the scale and number symbols of the display area. Depending on the type of the color pigments, the ring element can also light up in red, orange, yellow or green or in other color nuances, without an extra light source having to be provided for such an illumination ring.

In a further embodiment, the chromatographically colored ring element projects out of the ring groove so that the illumination effect can thereby be amplified. The projecting area of the ring element in this case can have a scattering lens contour in cross section and further improve the illumination effect. It is provided, furthermore, that the support disc comprises an outer support disc ring and an inner support disc ring and between the support disc rings the chromatographically colored ring element is arranged. In this case, the chromatographically colored ring element completely penetrates the support disc and is illuminated over the entire depth through the nanoparticles in the adjacent support disc rings when the light sources on the outer margins of the support disc are switched on when starting the vehicle.

In a further embodiment, the chromatographically colored ring element comprises differently colored ring segments, which let display areas light up in color. The display areas which light up in color can characterize different measuring ranges, such as normal cooling water temperature ranges green, critical cooling water temperature ranges yellow and impermissible cooling water temperature ranges red.

Apart from the foregoing, different dial ranges can let chromatographically colored warning functions or traffic information light up. However, to this end, individually switchable light sources are provided in the illumination device which are oriented at these dial areas with chromatographically colored warning functions. On the other hand it is also possible to let different color gradations light up for safety-relevant borderline regions, in order for example to draw the driver's attention to danger situations.

To this end, the illumination device comprises at least one light source, whose light rays are oriented at the outer margin of the support disc such that the nanoparticles in the support disc let the support disc light up. The arrangement of the light sources of the illumination device has already been discussed extensively above and is exemplarily explained with the attached Figures in detail so that it is not additionally discussed at this point.

In order to tangentially couple the light of the light source into the outer edge of the support disc as described above it is provided that the outer margin of the support disc comprises clearances, which form radially oriented shoulders with coupling surfaces, at which the light rays of the light sources or light conductors, which are connected to the light sources, are oriented. In this connection, reference is again made to the following Figures which show different coupling-in possibilities for both light conductors as well as light-emitting diodes in order to cause the support disc to light up.

In principle, scale symbols and number symbols as well as signs and letter symbols can be directly applied to the support disc in that in the display area the support disc comprises a non-transparent coating with scale, number or sign and character symbols, which are free of the non-transparent coating, so that these light up brightly in the scattered light of the nanoparticles. On the other hand it is also possible in regions of the scales, the numbers or the signs and characters to apply a color transparent coating so that certain scales, signs of symbols can be emphasized in color. For example, a green scale range, a yellow scale range and a red scale range with increasing rotational speed can be provided for a dial displaying a rotational speed. Similar can be realized for fuel gauges, water temperatures etc., without having to employ additional or separate light sources.

Instead of a coating, which can be directly printed on the support disc, it is also possible to provide a visually transparent covering foil with a non-transparent coating, wherein the scale and display symbols do not have any coating or a color-graduated coating. Thus, the support disc can be produced separately from the covering foil and the lettering for example according to the injection molding method and subsequently the prepared covering foil can be glued on radially within and radially without the illumination ring both in the display area as well as in an outer ring area.

A method for producing an instrument with dial for a motor vehicle can have the following method steps. Initially, an injection mold for a support disc of a PMMA (polymethyl methacrylate) plastic with light-scattering nanoparticles arranged in the volume is produced. In the process, a ring bulge is formed in the injection mold, which is to surround a display area of the support disc. Following, the support disc is injection molded with the help of the injection mold subject to forming a ring groove in the support disc as a copy of the ring bulge of the injection mold. Finally, this ring groove can be filled up with a transparently colored material so that the ring element can thus be completed in the support structure and illuminated by the scattering light of the nanoparticles of the light source.

This method has the advantage that no extra injection molding element has to be produced but that a ring groove in the support disc can be subsequently cast in or molded in with the suitably chromatographically colored transparent plastic. In an alternative method, the ring element is produced in a separate casting mold. In the process, an outer contour is realized for the ring element, which corresponds to the inner contour of the ring element or which is adapted to an intermediate space between a radially outer support disc region and an inner support disc region.

In the case of a separate production of a ring element, the ring element is subsequently installed in the ring groove or the intermediate space between the two support disc rings subject to the materially joined connection with the support disc or the support disc rings. The display area can be produced in that either the numbers, signs or other symbols are directly applied to the support disc or the ring element and the scale symbols, number symbols and sign symbols on a printed covering foil are recessed in the display area of the dial. Finally, the light sources of the illumination device are arranged in the instrument subject to orienting the radiation of the light sources to an outer edge of the support disc.

In a further embodiment, the materially joined connecting of the ring element to the support disc will be effected with melting-in or with a transparent adhesive. A dial produced such has the advantage that the number of the light sources can be reduced so that the operation of the instrument consumes less energy yet makes possible an improvement of the visibility and an emphasis of the display area.

### BRIEF DESCRIPTION OF THE DRAWINGS

The present invention will hereinafter be described in conjunction with the following drawing figures, wherein like numerals denote like elements, and:

FIG. 1 shows a schematic cross section through a dial of an instrument according to a first embodiment;

FIG. 2 shows a top view of the dial according to FIG. 1;

FIG. 3A shows a first part of a schematically expanded construction of the dial according to FIG. 1 in cross section;

FIG. 3B shows a second part of the schematically expanded construction of the dial according to the FIG. 1 in cross section;

FIG. 3C shows a third part of the schematically expanded construction of the dial according to FIG. 1 in cross section;

FIG. 4 shows a schematic cross section through a dial of an instrument according to a second embodiment;

FIG. 5 shows a top view of the dial according to FIG. 4;

FIG. 6A shows schematically a first part of an expanded construction of the dial according to FIG. 4 in cross section;

FIG. 6B shows schematically a second part of the expanded construction of the dial according to FIG. 4 in cross section;

FIG. 6C shows schematically a third part of the expanded construction of the dial according to FIG. 4 in cross section;

FIG. 7 shows a schematic cross section through a dial of an instrument according to a third embodiment;

FIG. 8 shows a top view of the dial according to FIG. 7;

FIG. 9A shows schematically a first part of an expanded construction of the dial according to FIG. 7 in cross section;

FIG. 9B shows schematically a second part of an expanded construction of the dial according to FIG. 7 in cross section;

FIG. 9C shows schematically a third part of an expanded construction of the dial according to FIG. 7 in cross section;

FIG. 10 shows a schematic cross section through a dial of an instrument according to a fourth embodiment;

FIG. 11 shows a top view of the dial according to FIG. 10;

FIG. 12A shows schematically a first part of an expanded construction of the dial according to FIG. 10 in cross section;

FIG. 12B shows schematically a second part of an expanded construction of the dial according to FIG. 10 in cross section;

FIG. 12C shows schematically a third part of an expanded construction of the dial according to FIG. 10 in cross section;

FIG. 13 shows a schematic cross section through a dial of an instrument according to a fifth embodiment;

FIG. 14 shows a top view of the dial according to FIG. 13;

FIG. 15A shows schematically a first part of an expanded construction of the dial according to FIG. 13 in cross section;

FIG. 15B shows schematically a second part of the expanded construction of the dial according to FIG. 13 in cross section;

FIG. 15C shows schematically a third part of the expanded construction of the dial according to FIG. 13 in cross section;

FIG. 16 shows a schematic cross section through a dial of an instrument according to a sixth embodiment;

FIG. 17 shows a top view of the dial according to FIG. 16;

FIG. 18A shows schematically a first part of an expanded construction of the dial according to FIG. 6 in cross section

FIG. 18B shows schematically a second part of the expanded construction of the dial according to FIG. 6 in cross section; and

FIG. 18C shows schematically a third part of the expanded construction of the dial according to FIG. 6 in cross section.

### DETAILED DESCRIPTION

The following detailed description is merely exemplary in nature and is not intended to limit application and uses. Furthermore, there is no intention to be bound by any theory presented in the preceding background or summary or the following detailed description.

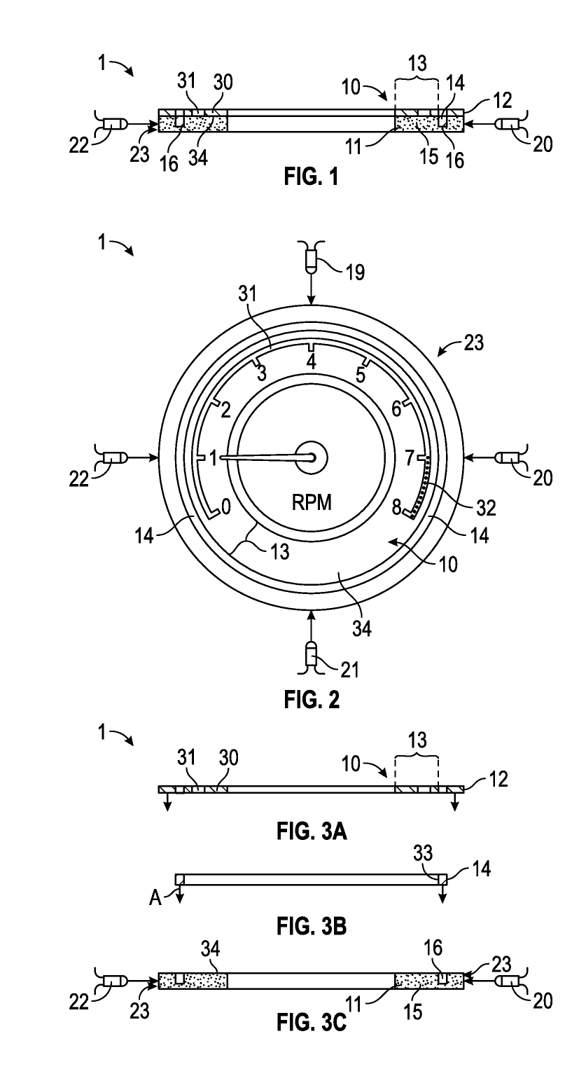

FIG. 1 shows a schematic cross section through a dial 10 of an instrument 1 according to a first embodiment. The dial 10 comprises a support disc 11, which comprises a display area 13 and a ring element 14 integrated in the support disc, which surrounds the display area 13. The support disc 11 is produced from a light-conductive material such as PMMA (polymethyl methacrylate).I The volume of the light-conductive material nanoparticles are arranged in a distributed manner, which lets the transparent support disc 11 light up when irradiated by light sources 20 and 22 since the nanoparticles 15 scatter the light of the light sources 20 and 22 coupled in via an outer edge 23 so that the support disc of transparent light-conductive material lights up and also lets the ring element 14 of a transparently colored plastic material light up, since this ring element 14 is embedded in a ring groove 16 of the support disc 11.

The support disc 11 can on its top side 34 be covered by a non-transparent coating 30. Scale symbols 31 and number symbols and signs and letter symbols do not have any coating and are thereby brought to light up by the support disc 11 when the light sources 20 and 22 are switched on. At the same time, the color ring element 14 which is integrated in the ring groove 16 will light up so that the display area 13 of the instrument 1 is emphasized and the visibility is increasingly underscored.

FIG. 2 shows a top view of the dial 10 according to FIG. 1. As is visible in the top view, the chromatographically colored ring element 14 surrounds the display area 13 of this exemplary rotational speed measuring instrument 1. The numbers 1 to 8 have to be multiplied by the factor 1,000 in order to be able to read off the rotational speed in revolutions per minute. The scale symbols 31 form an open ring which in the end region between approximately 7,000 and approximately 8,000 revolutions per minute comprises a graduated coating 32 for example in red in order to symbolize impermissible rotational speeds.

A further rotational speed range for example between approximately 5,000 and approximately 7,000 revolutions per minute can also warn the driver against excessively high rotational speeds through a yellow gradation. Opposite the open ring of the scale symbols 31, a transparent illumination ring in the form of the ring element 14 can for example be colored in blue by means of suitable color pigments and surround the display area 13 in order to concentrate the attention of the driver on the display area. As already mentioned above, this ring is brought to light up without additional light sources since it, as shown by the cross section in FIG. 1, it is surrounded from three sides by the light-scattering material of the support disc 11.

Apart from this, a radial arrangement of the light sources is shown with FIG. 2, which directs their rays onto the outer edge 23 of the support disc 11. In this embodiment four light sources 19 to 22 in the form of light-emitting diodes are radially directed onto the outer edge 23 of the dial 10, as a result of which the outer diameter of the instrument 1 or of the housing of the instrument 1 has to be designed suitably large, while on the other hand this arrangement of the light sources 19 to 22 makes possible an extremely flat embodiment of the instrument 1.

FIG. 3 shows a schematic expanded construction of the dial according to FIG. 1 in cross section. FIG. 3 thereby shows that the dial of this first embodiment of the invention with symbols from three components, namely the support disc 11, the ring element 14 and a covering foil 12. The covering foil 12 can carry the abovementioned coating 30 and merely the scale symbols, number symbols or letter and sign symbols are free of coating and otherwise surrounded by the non-transparent coating.

The ring element 14 of a transparent plastic with color pigments can be fitted into a ring groove 16 of the support disc 11 so that this ring becomes an integral part of the support disc 11 when it is inserted in the ring groove 16 in the arrow direction A and connected to the material of the support disc 11 in a materially joined manner. This can also be affected in that the ring groove 16 is filled up with the material of the illumination ring so that no separate ring element 14 has to be produced but merely the ring groove 16 has to be filled up. Instead of the separately prepared foil 12 with the number, sign, letter and figure symbols, and the top side 34 of the support disc 11 can be covered with a textured and non-transparent coating.

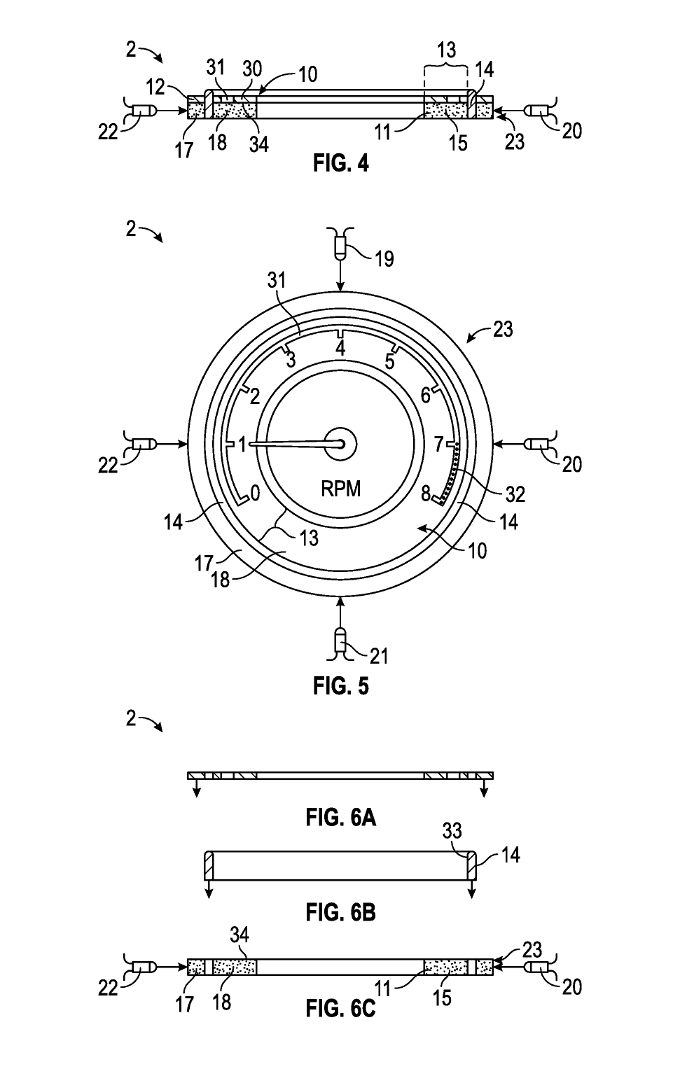

FIG. 4 shows a schematic cross section through a dial 10 of an instrument 2 according to a second embodiment. Components with the same functions in the following figures as in the preceding figures are marked with the same reference characters in the following and not explained separately. This second embodiment differs from the first embodiment of the invention in that the support disc is a symbol of two support disc rings, namely an outer support disc ring 17 and an inner support disc ring 18. Here, the inner support disc ring 18 comprises the display area 13 and the outer support disc ring comprises an outer edge 23, via which the light of the light sources 20 and 22 is coupled in, where the ring element 14 arranged between the two support disc rings 17 and 18 is brought to light up. The ring element 14 in this and the following embodiments projects over the top side 34 of the support disc 11 and in cross section has a scattering lens-like profile in the projecting region.

FIG. 5 shows a top view of the dial 10 according to FIG. 4. The position of the ring element 14 becomes clear in an intermediate space between the two support disc rings 17 and 18 and FIG. 6 shows the construction of the dial from three main parts with the FIGS. 6a, 6b and 6c as in FIG. 3 with two separate rings for the covering foil 12 and two support disc rings for the support disc 11.

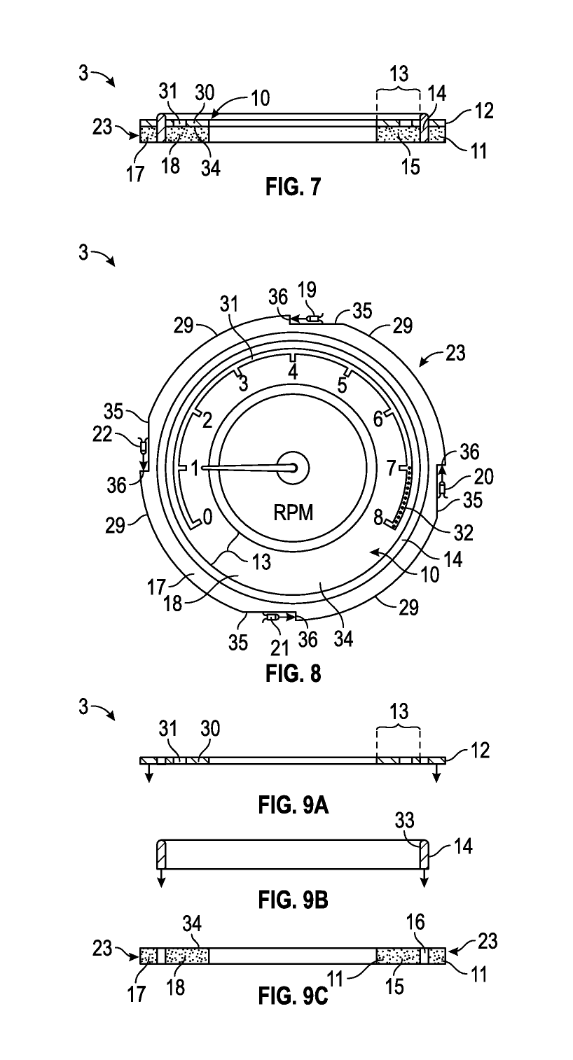

The following FIG. 7 to FIG. 18 show four further embodiments in which the light sources are oriented at the outer edge of the dial at different angles, which is supported by differently arranged mirrored coatings on the outer edge of the support disc.

FIG. 7 shows a schematic cross section through a dial 10 of an instrument 3 according to a third embodiment. In this cross section the light sources, as were shown in the preceding figures, are not visible since, as shown in FIG. 8, the light sources 19, 20, 21 and 22 in the form of light-emitting diodes are oriented tangentially to the outer edge 23 of the dial 10. For tangentially coupling the light into the support disc 11, a mirrored coating 29 is partially applied onto the outer edge 23. Furthermore, recesses 35 are worked into the outer edge 23, which receive the light sources 19 to 22 in the form of light-emitting diodes and each have a radially oriented shoulder 36, onto which the rays of the light sources 19 to 22 are oriented so that a tangential coupling-in of the radiation in the support disc 11 is obtained.

FIG. 9 in turn shows the construction of the dial from three main components with the FIG. 9a to FIG. 9c, as already shown in FIG. 6. The light-emitting diodes previously illuminating the outer edge 23 of the support disc 11 radially are no longer present since these are replaced with light-emitting diodes oriented tangentially to the outer edge 23 as shown in FIG. 8.

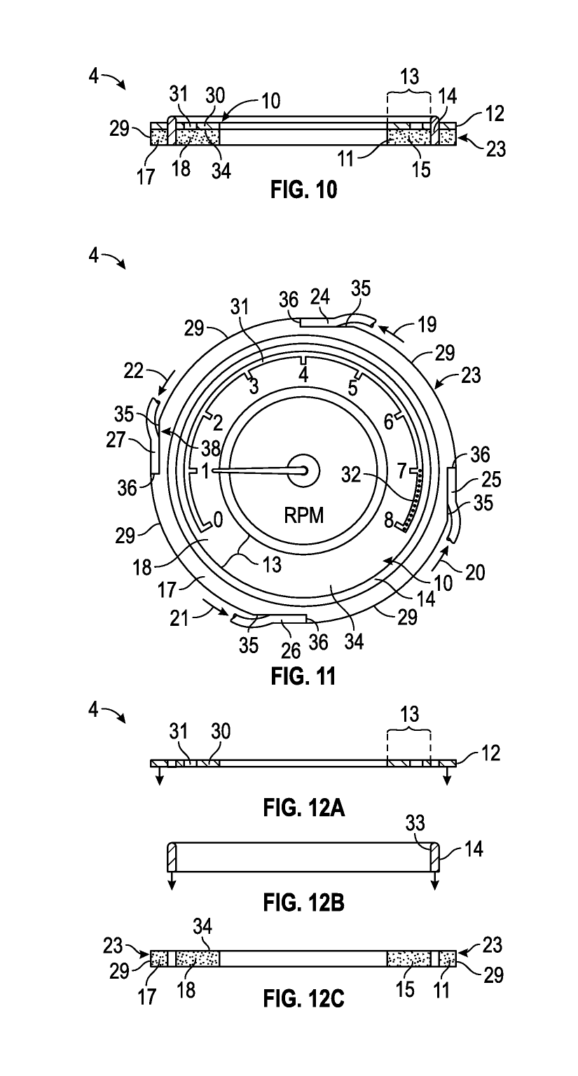

FIG. 10 shows a schematic cross section through a dial 10 of an instrument 4 according to a fourth embodiment. In this cross section through the dial 10 does not differ from the preceding cross section of FIG. 7, since here, too, a tangential irradiation of the light in the dial 10 takes place.

Accordingly, as shown by FIG. 11, recesses 35 are provided on the outer edge 23 of the dial 10, which however in this fourth embodiment of the invention receive ends of light conductors 24 to 27, which can be connected to light sources 19 to 22 or are routed to a central light source of an instrument panel, so that from there light is tangentially coupled into the support disc 11 via the light conductors 24 to 27 onto the radially oriented shoulders 36 of the otherwise mirrored outer edge 23 of the dial 10. For this purpose, the ends of the light conductors 24 to 27 can be connected to the radially oriented shoulders 36 for reducing optical losses through material joining by means of a transparent adhesive, whose refractive index is adapted to the refractive indices of the light conductors 24 to 27 and the support disc 11.

FIG. 12 shows schematically an expanded construction of the dial 10 according to FIG. 10 in cross section, which makes it clear that the outer diameter of an instrument 4 of this fourth embodiment can be significantly smaller than with the first two embodiments with unchanged flat construction of the instrument 4.

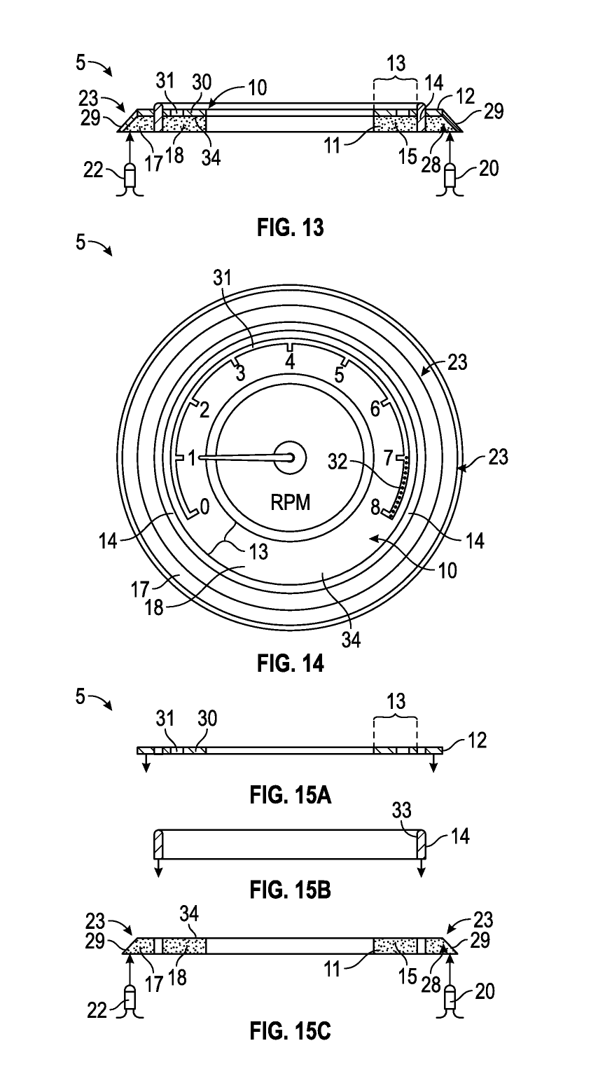

FIG. 13 shows a schematic cross section through a dial 10 of an instrument 5 according to a fifth embodiment. In this embodiment, the light sources 20 and 22 are oriented orthogonally to the support disc 11 of the dial 10 and irradiate an outer edge 23 of the support disc 11, which is provided with an approximately 45° chamfer and has a mirrored coating 29 so that the irradiation through the light sources 20 and 22 is reflected on the mirrored coating 29 and oriented to the light-scattering nanoparticles 15. With this embodiment, the outer diameter of the dial is merely enlarged by the chamfered bevel, as shown by FIG. 14.

FIG. 15 shows with the FIG. 15a to FIG. 15c again schematically an expanded construction of the dial 10 according to FIG. 13 in cross section, where with FIG. 15c the orientation of the light sources 20 and 22 to the mirrored coating 29 of the chamfer 28 of the outer edge 23 becomes clear.

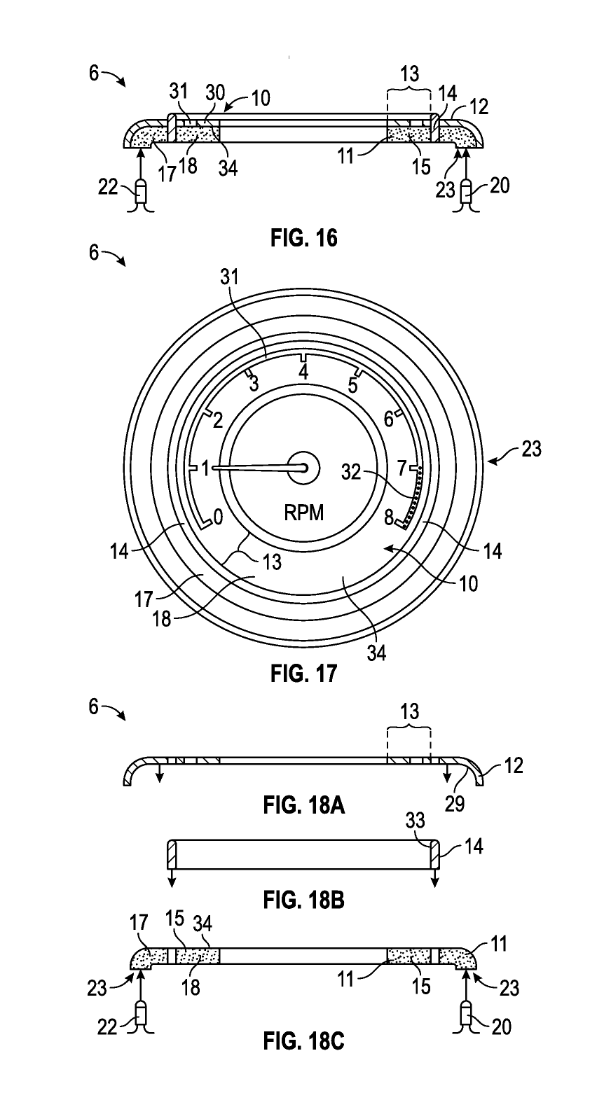

FIG. 16 shows a schematic cross section through a dial 10 of an instrument 6 according to a sixth embodiment. This embodiment differs from the preceding embodiments in that the outer edge 23 of the support disc 11 is angled off or bent off so that in this embodiment of the invention the light sources 20 and 22 can also be oriented orthogonally to the dial 10 or the support disc 11. In the top view of FIG. 17, the dial 10 completely covers the light sources and only with FIG. 18 and the expanded construction of the dial 10 it becomes clear again that the outer diameter of the instrument 6 is only slightly larger than with the third and fourth embodiments, however smaller than with the first and second embodiments. It is shown furthermore with FIG. 18a that the covering foil 12 in the bent-off edge region can comprise a mirrored inner coating 29 in order to support the deflection of the radiation of the light sources 20 and 22, as is shown by FIG. 18c.

Although exemplary embodiments have been shown in the preceding description, different changes and modifications can be carried out. The mentioned embodiments are merely examples and not intended to restrict the range of validity, the applicability or the configuration in any way. The preceding description merely makes available to the person skilled in the art a plan for implementing at least one exemplary embodiment, where numerous changes in the function and the arrangement of elements described in the exemplary embodiments can be made without leaving the scope of protection of the attached claims and their legal equivalents.

1. An instrument for a motor vehicle, comprises:
a support disc;
a display area on the support disc; and
a transparent chromatographically colored ring element that surrounds the display area,
wherein the support disc comprises a transparent light conductor plate in which the transparent chromatographically colored ring element is arranged, and
wherein the transparent light conductor plate in a volume comprises light-scattering nanoparticles.

2. The instrument dial according to claim 1, wherein the transparent chromatographically colored ring element comprises a transparent plastic in which color pigments are arranged in a homogeneously distributed manner.

3. The instrument dial according to claim 1, wherein the support disc comprises a ring groove that surrounds the display area and in which the transparent chromatographically colored ring element is embedded.

4. The instrument dial according to claim 3, wherein the transparent chromatographically colored ring element is configured to project out of the ring groove.

5. The instrument dial according to claim 1, wherein the support disc comprises:
an outer support disc ring; and
an inner support disc ring,
wherein the transparent chromatographically colored ring element is arranged between the outer support disc ring and the inner support disc ring.

6. The instrument dial according to claim 1, wherein an illumination device comprises at least one light source having light rays oriented to an outer edge of the support disc such that nanoparticles in the support disc allow the support disc to light up.

7. The instrument dial according to claim 6, wherein the support disc comprises the transparent light conductor plate having a polymethyl methacrylate plastic with the nanoparticles.

8. The instrument dial according to claim 1, wherein the transparent chromatographically colored ring element is configured to provide differently colored ring segments light up in color as display areas.

9. The instrument dial according to claim 8, wherein the display areas lighting up in color characterize with different measuring ranges.

10. The instrument dial according to claim 9, wherein different dial ranges are configured to light up chromatographically colored warning functions.

11. The instrument dial according to claim 6, wherein different color gradations are configured to light up safety-relevant limit ranges.

12. The instrument dial according to claims,
wherein a covering foil is visually transparent and comprises a visually non-transparent coating, and
wherein a coating is absent from a scale and a display symbol.

13. A method for producing an instrument with a dial for a motor vehicle, comprising:
injection molding a support disc with an injection mold from a polymethyl methacrylate plastic with light-scattering nanoparticles arranged in a volume, wherein a ring bulge is formed in the injection mold;
injection molding the support disc in the injection mold subject to form a ring groove in the support disc as a copy of the ring bulge of the injection mold;
filling the ring groove with a transparent chromatographically colored polymethyl methacrylate plastic to a ring element.

14. The method according to claim 13, further comprising:
injection molding the ring element with color pigments arranged in the volume, an outer contour of corresponding to a profile of the ring bulge;
inserting the ring element in the ring groove subject to connecting the ring element by material joining with the support disc;
printing of a one-sided adhesive covering foil in a display area with partial color scales;
applying the one-sided adhesive covering foil subject to recessing the ring element; and
arranging light sources of an illumination device subject to orienting radiation of the light sources to an outer edge of the support disc.

15. The method according to claim 14, wherein the material joining of the ring element to the support disc is affected with melting-in a transparent adhesive.
